(19) United States
(12) Patent Application Publication
(10) Pub. No.: US 2017/0058605 A1
(43) Pub. Date: Mar. 2, 2017

(54) ROOF MOUNTED LADDER BRACKET SYSTEM

(71) Applicant: Michael J. Napolitano, Coventry, CT (US)

(72) Inventor: Michael J. Napolitano, Coventry, CT (US)

(21) Appl. No.: 14/819,323

(22) Filed: Aug. 28, 2015

(51) Int. Cl. E06C 7/48

(52) U.S. Cl. CPC E06C 7/488

(57) ABSTRACT

A ladder stabilizing system for incorporation into a roofing system and for receiving and releasably retaining a ladder therein. The ladder stabilizing system includes a mounting plate disposed between layers of the roofing material and further includes a ladder bracket fixedly attached to the mounting plate and includes a section adapted to accommodate the features of the edge of the roofing system. The ladder bracket further includes a set of lateral supports for receiving the ladder there between and retention members for releasably securing the ladder to the ladder stabilizing system.

### BACKGROUND OF THE INVENTION

Field of the Invention

Embodiments of the present invention generally relate to a safety device for securing a ladder and protecting a building and, more particularly, to a roof mounted ladder bracket system.

Description of the Related Art

Safety and stability are of the utmost importance when using a ladder to access the roof of a building. The use of a ladder in such circumstances is inherently dangerous and a worker falling from a ladder can sustain life-threatening injuries. Attempts at increasing the safety of utilizing a ladder to access the roof of a building have fallen short of solving several problems. Ladder stabilizers of the prior art that attach to or cooperate with the bottom of the ladder do not protect the areas of the building where the ladder contacts the building and to a large extent do not prevent the ladder from falling backwards from the building due to an overturning moment. Prior art ladder stabilizer devices that do incorporate features to prevent the ladder from falling due to an overturning moment lack the ability to accommodate many of the features found in commercial buildings and further they compromise the integrity of these roofing systems. It is highly likely that the use of any of these prior art devices would void the warranty offered by manufacturers of commercial roofing systems.

The prior art includes devices that include a support pad or platform to stabilize the bottom of the ladder including U.S. Pat. No. 6,490,842. The prior art further includes stabilizing devices that attach to a ladder purporting to allow a person to safely access roofs such as those described in U.S. Pat. Nos. 6,837,338, 6,408,983, 6,152,262, 7,293,630, 7,753,170 7,757,814 as well as U.S. Patent application numbers 2003/0188924, 2007/0267251, and 2011/0127110. Even if these types of devices function as described, they do little, if anything, to protect the features of a building at the point of contact with the ladder. In addition none of these prior art devices adequately addresses the danger of a ladder falling away from the building due to an overturning moment acting on the ladder.

Some other prior art devices attach to building structure to prevent damage to the building when a ladder is used such as described in U.S. Pat. Nos. 6,578,665 and 6,722,469. Still other prior art ladder stabilizing devices attach to removable platforms that protect the roofing structure such as those described in U.S. Pat. No. 8,783,415. While devices which embody these prior art inventions may protect the building from contact with a ladder they do not incorporate features that integrate with the roofing system to provide for a permanently installed device that ensures the integrity of the roofing system, especially with regard to modern commercial roofing systems. For instance, while the invention describe in U.S. Pat. No. 6,722,469 may protect the edge of some structures it lacks any features to accommodate and protect an edge mounted drip lip common in commercial construction. Furthermore, although the invention describe in U.S. Pat. No. 6,722,469 may be mounted below the roof covering it does not describe a method for ensuring the integrity of the roofing system or the ongoing integrity of the bracket itself in so much as the fasteners are non-inspectable.

Therefore, there exists a need for a ladder stabilization system intended for permanent installation that reliably and safely stabilizes a ladders while accommodating commercial roofing features and maintaining the integrity of modern roofing systems.

### SUMMARY OF THE INVENTION

The invention generally relates to a roof mounted ladder stabilizing system. for incorporation into a roofing system and for receiving and releasably retaining a ladder therein. The ladder stabilizing system includes a mounting plate disposed between layers of the roofing material and further includes a ladder bracket fixedly attached to the mounting plate and includes a section adapted to accommodate the features of the edge of the roofing system. The ladder bracket further includes a set of lateral supports for receiving the ladder there between and retention members for relasably securing the ladder to the ladder stabilizing system.

An embodiment of the present invention ladder stabilizing system for use with a roofing system includes a mounting plate incorporated into and fixedly attached to a portion of the roofing system wherein the mounting plate includes at least one fastener. The ladder stabilizing system further includes a ladder bracket having a first section for engagement with the at least one fastener of the mounting plate for fixedly attaching the bracket to the roofing system. The bracket also includes a second portion adapted to accommodate an edge of the roofing system and to receive a ladder. The second portion of the bracket further includes at least one lateral support extending therefrom and a retention member.

In an embodiment of the present invention the retention member releasably fixes the ladder to the ladder stabilizing bracket and further includes a pair of lateral supports extending from the ladder stabilizing bracket and positioned to receive the ladder there between.

In yet another embodiment of the present invention ladder stabilizing system of the mounting plate includes threaded studs and the ladder bracket is fixedly attached to the mounting plate studs by threaded.

In still another embodiment of the present invention the roofing system is comprised of a sheathing material and the mounting plate is disposed between layers of sheathing material.

In yet another embodiment the roofing system includes a drip lip and the second portion is adapted to accommodate the drip lip.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates various features of the roof mounted ladder stabilizing system, in accordance with certain aspects of the present disclosure.

FIG. 2 is a front view of an example roof mounted ladder stabilizing system, in accordance with certain aspects of the present disclosure.

FIG. 3 is a side view in partial section of an example roof mounted ladder stabilizing system, in accordance with certain aspect of the present disclosure.

FIG. 4 illustrates an example of a backing plate and sealing layer of a roof mounted ladder stabilizing system, in accordance with certain aspects of the present disclosure.

### DETAILED DESCRIPTION

The ladder securing systems of the prior art have limitations of safely securing the ladder against a building while maintaining the overall integrity of the building and roof. Therefore, certain embodiments of the present invention provide for safely and easily releasably securing a ladder to the side of a building while overcoming the limitations of the prior art.

### EXAMPLE ROOF MOUNTED LADDER BRACKET SYSTEM

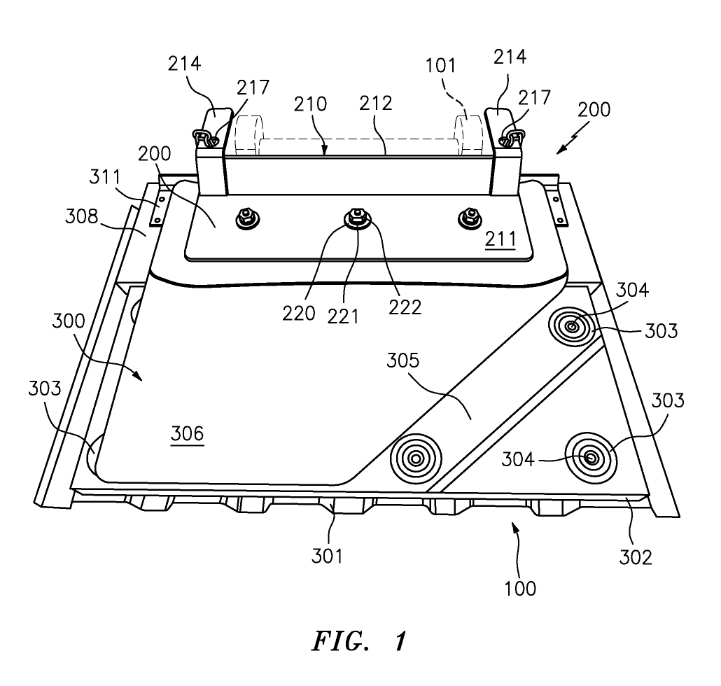

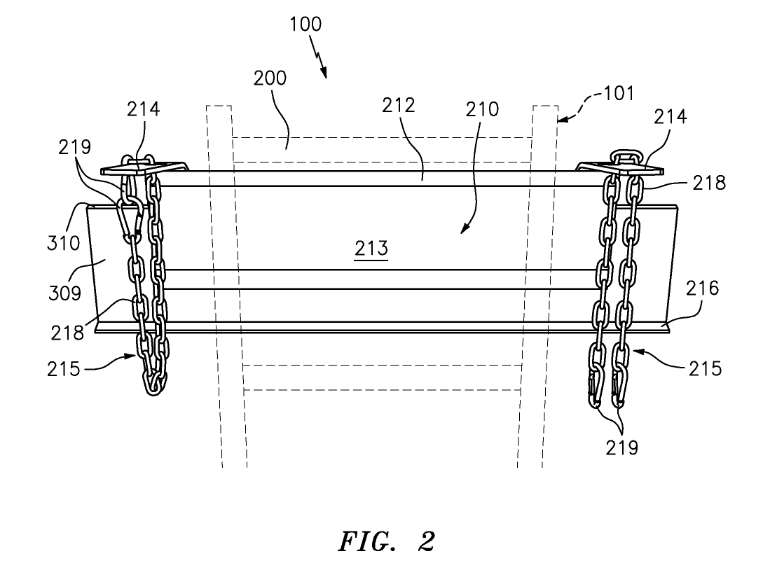

FIGS. 1-4 illustrate an exemplary roof mounted ladder stabilizing system 100 including ladder bracket system 200 integrally mounted to roofing system 300 for securing and stabilizing ladder 101.

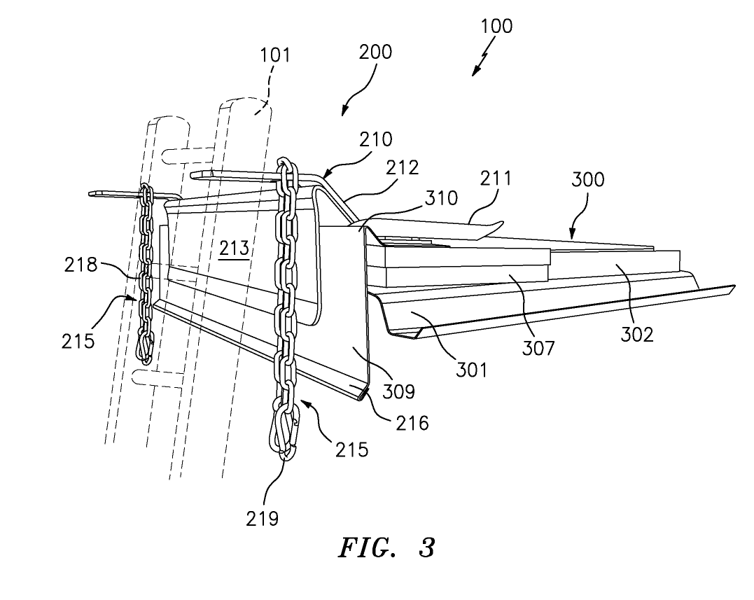

The features and components of an example of a modern commercial roofing system is best described with reference to FIG. 1. The roofing system 300 shown in FIG. 1 is a typical modern day commercial roofing system comprising various layers and utilizing a thermoplastic membrane as the top layer for preventing moisture ingression. The present invention may include any known or contemplated membrane and roof system materials including thermoplastic membranes or ethylene propylene diene monomer EPDM rubber and will be described herein with specific reference to thermoplastic polyolefin (TPO) roofing system materials. Roof system 300 includes a substrate such as corrugated metal sheeting 301 that is fastened to the rafters of a building structure in a known way utilizing appropriate fasteners (not shown). A layer of insulation 302 which may be comprised of a polyisocyanurate material is applied on top of corrugated metal sheeting 301 and fastened thereto using washers 303 and fasteners 304. The example roof system 300 further comprises a TPO bonding adhesive 305 layered on top of the insulation 302 and attached thereto by washers 303 and fasteners 304. Roofing system 300 further includes a top layer of 0.060 inch thick TPO membrane 306 which is heat welded to the TPO adhesive layer 305 and heat welded along lap joints with subsequent TPO membrane layers (not shown). Now with reference to FIG. 3 TPO roof system 300 further comprises a nailer strip 307 which in this example system comprises a kiln dried Douglas Fir that is fastened to corrugated metal sheeting 301 using suitable fasteners 308 (FIG. 1). Still referring to FIG. 3 the edge of TPO roof system 300 comprises a TPO clad metal edge 309 that includes a drip lip 310 formed therein and projecting upward therefrom and wherein the metal edge is fastened to nailer strip 307 using appropriate nails 311. The example TPO roofing system 300 provides aesthetic, structural, thermal and moisture integrity for a building (not shown). It is contemplated that the present invention includes roofing systems other than that described herein above including different substrate materials and configurations, different insulation materials, backing boards, adhesives, caulks, fasteners and the like.

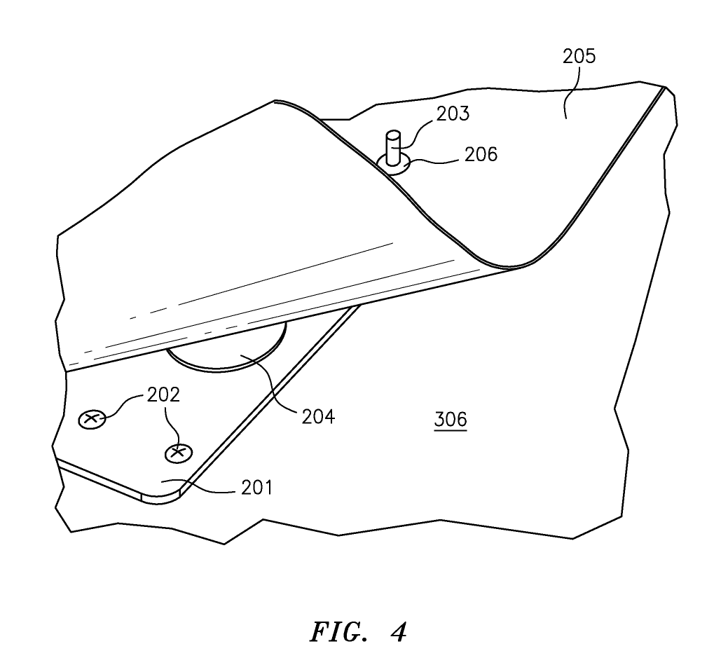

The roof ladder bracket system 200 of the present invention is integrated with the TPO roofing system 300 and it further maintains the aesthetic, structural, thermal and moisture integrity of the roofing system. With reference to FIG. 4 roof ladder bracket system 200 includes a mounting plate 201 fastened to the nailer strip 307 using fasteners 202. Mounting plate 201 is advantageously comprised of a corrosion resistant metal such as an aluminum alloy having a dimension of about 0.125 inches thick, 4 inches wide and 24 inches long. Mounting plate 201 includes a plurality of mounting studs 203 fixed thereto and may be comprise of 0.375 inch diameter by 1.125 inch long course thread steel bolts. In order to insure the moisture integrity of roofing system 300 a sufficient amount of a TPO compatible sealant 204 is applied on the top of mounting plate 201 and may further be applied to the bottom side of mounting plate 201 (not shown). A mounting plate cover 205 comprised of 0.060 inch thick TPO membrane material is applied over mounting plate 201 and includes holes positioned at predetermined locations to allow mounting studs 203 to protrude there through. Mounting plate cover 205 is heat welded to membrane 306 and to TPO clad metal edge 309. An appropriate TPO compatible caulking 206 is applied in an amount capable of providing a watertight seal around mounting studs 203. Once mounting plate cover 205 is heat welded to membrane 306 and to TPO clad metal edge 309 and caulking 206 is applied, the moisture proof integrity of the roofing system 300 is maintained. The mounting plate, various features, mounting methods and sealing techniques may comprise other materials and configurations without deviating from the present invention.

With reference to FIGS. 1-3 an example of roof ladder bracket system 200 includes bracket 210 which is comprised of a formable and weldable metal and may comprise an aluminum alloy. However, bracket 210 may be comprised of any suitable material including steel, plastic, composite or other material with deviating from the spirit of the present invention. In this example embodiment, bracket 210 is fabricated from 0.250 inch aluminum sheet material and includes a generally planar section 211, drip edge relief section 212, fascia section 213, lateral legs 214 and ladder retention members 215. Planar section 211 includes holes positioned at predetermined locations to allow mounting studs 203 to protrude there through during attachment as will be more fully described herein after. Drip edge relief section 212 and facia section 213 are formed from a single sheet of aluminum material contiguous with planar section 211 using known metal forming techniques. Lateral legs 214 are comprised of a substantially similar material, are formed to match the contour of drip edge relief section 211, and are fixedly attached thereto, preferably by welding. In the embodiment shown the dimensions of planar section 211 is approximately 24 inches by 6 inches, drip edge relief section 211 extends approximately 3 inches from planar section 211 and facia section 213 extends approximately 6 inches from drip edge relief section. Facia section 213 further includes a bent section 214 at its bottom most portion for deflecting water away from the building. Lateral legs 214 are approximately 2 inches wide, are welded to drip edge relief section 211 and extend outwardly therefrom approximately 5 inches. Lateral legs 214 further include a hole 217 therein to accommodate ladder retention member 215. In the example shown, retention member 215 is comprised of a 21 inch long chrome plated steel chain 218 having 1 inch links and further includes a pair of quick release clips 219 positioned at either end of the chain. The present invention includes alternative retention member 215 including rope, cable, strapping, etc.

With reference to FIG. 1, roof ladder bracket system 200 is completed when bracket 210 of roof mounted ladder stabilizing system 100 is mounted to mounting studs 203 of mounting plate 201 and is secured by flat washers 220, lock washers 221 and nuts 222. The bracket may be semi-permanently secured using a thread adhesive or permanently installed by welding nuts 222 to mounting studs 203. With the roof ladder bracket system of the present invention installed as described the structural, aesthetic and moisture integrity of the roofing system is maintained. Further, and with specific regard to safety, with the ladder bracket secured to the mounting plate as described, the condition of the bracket and its attachment can be easily inspected. If the bracket has become damaged it can easily be recognized and replaced. Similarly, if any of the nuts become loose or are missing they can easily be recognized and replaced.

### APPLICATION

For certain embodiments, roof mounted ladder stabilizing system 100 is particularly useful for securing a ladder to allow a user to safely access the roof of a commercial building.

FIGS. 1-3 illustrate an example roof mounted ladder stabilizing system 100 for securing a ladder to a commercial building. With the roof ladder bracket system 200 fixedly attached to the roof system 300 a user (not shown) extends a ladder 101 to the proper height above the level of the lateral supports 214 and further positions the ladder between the lateral supports and places the legs of the ladder against fascia section 213. The user should position the base of the ladder 101 one foot away from the building for every four feet of height to fascia section 213. In most cases, the ladder 101 should extend 3 feet past the ladder supports 214. The user then ascends the ladder and secures the ladder to the roof mounted ladder stabilizing system 100 using the ladder retention members 215. Although not explicitly shown in the figures, the user wraps chains 218 around each leg of the ladder 101 and releasably secures the chains thereto using quick release clips 219. With ladder 101 positioned against the fascia section 213 the TPO clad metal edge 309 and drip lip 310 are protected from damage that may otherwise be cause by the ladder. Lateral supports 214 prevent the ladder 101 from sliding to either side and preventing a fall. Ladder retention members 215 resist an overturning moment acting on ladder 101 and thereby prevent the ladder from falling away from the building.

While roof mounted ladder stabilizing system 100 has been described specific regard to a commercial roof system the present invention may be used with any known or contemplated roof system where features of the roof require physical protection and where the structural, aesthetic and moisture integrity of the roofing system needs to be maintained.

While the foregoing is directed to embodiments of the present invention, other and further embodiments of the invention may be devised without departing from the basic scope thereof, and the scope thereof is determined by the claims that follow.

1. A ladder stabilizing bracket comprising:
a first substantially planar portion having a top side and a bottom side and including at least one mounting hole disposed therein to securely mount the bottom side to a roof of a roofing system;
a second substantially planar portion extending from the first planar portion and adapted to accommodate an edge of a roofing system; and
at least one lateral support extending from the ladder stabilizing bracket to prevent a ladder from sliding to a side of the ladder stabilizing bracket.

2. The ladder stabilizing bracket of claim 1 further comprising at least one retention member for releasably fixing the ladder to the ladder stabilizing bracket.

3. The ladder stabilizing bracket of claim 1 wherein the at least one lateral support comprises a pair of lateral supports extending from the ladder stabilizing bracket and positioned to receive a ladder there between.

4. The ladder stabilizing bracket of claim 1 further comprising a mounting plate having a bottom side and a top side and wherein the bottom side is fixedly attached directly to a portion of a roof of the roofing system and the mounting plate including at least one fastener projecting from the top side.

5. The ladder stabilizing bracket of claim 4 wherein the at least one fastener of the mounting plate is engaged within the mounting hole of the first substantially planar portion for fixedly attaching the ladder stabilizing bracket to the mounting plate.

6. The ladder stabilizing bracket of claim 4 wherein the at least one fastener is a threaded stud projecting from the top side of the mounting plate and rigidly affixed thereto.

7. The ladder stabilizing bracket of claim 1 wherein the roofing system comprises a membrane sheathing material.

8. The ladder stabilizing bracket of claim 1 wherein the edge of the roofing system includes a drip lip.

9. The ladder stabilizing bracket of claim 1 wherein the ladder stabilizing bracket is comprised of a corrosion resistant metal.

10. The ladder stabilizing bracket of claim 1 wherein the ladder stabilizing bracket is comprised of a formed and welded aluminum alloy.

11. A ladder stabilizing system for use with a roofing system, the ladder stabilizing system comprising:
a mounting plate having a bottom side and a top side and wherein the bottom side is fixedly attached directly to a roof of the roofing system and the mounting plate including at least one fastener projecting from the top side;
a ladder bracket comprising:
a first substantially planar portion having a top side and a bottom side and including at least one mounting hole disposed therein to engage with the at least one fastener of the mounting plate to fixedly attach the bottom side of the first substantially planar portion to the top side of the mounting plate;
a second substantially planar portion extending from the first planar portion and adapted to accommodate an edge of the roofing system and adapted to receive a ladder;
at least one lateral support extending from the ladder bracket to prevent the ladder from sliding to a side of the ladder stabilizing bracket.

12. The ladder stabilizing system of claim 11 further comprising at least one retention member for releasably fixing the ladder to the ladder stabilizing bracket.

13. The ladder stabilizing system of claim 11 wherein the at least one lateral support comprises a pair of lateral supports extending from the ladder stabilizing bracket and positioned to receive the ladder there between.

14. The ladder stabilizing system of claim 11 wherein the first substantially planar portion is adapted to engage with the at least one fastener of the mounting plate for fixedly attaching the ladder stabilizing bracket to the roofing system.

15. The ladder stabilizing bracket of claim 11 wherein the at least one fastener is a threaded stud projecting from the top side of the mounting plate and the ladder system further comprising a threaded nuts for engaging the threaded stud and rigidly affixing the ladder bracket to the mounting plate.

16. The ladder stabilizing system of claim 1 wherein the roofing system comprises a membrane sheathing material.

17. The ladder stabilizing system of claim 16 wherein the mounting plate is disposed between layers of sheathing material.

18. The ladder stabilizing system of claim 1 wherein the edge of the roofing system includes a drip lip.

19. The ladder stabilizing system of claim 1 wherein the ladder stabilizing bracket is comprised of a corrosion resistant metal.

20. The ladder stabilizing bracket of claim 1 wherein the ladder stabilizing bracket is comprised of a formed and welded aluminum alloy.

21. The ladder stabilizing bracket of claim 17 further comprising a sealant material disposed between the layers and mounting bracket.
